(19) United States
(12) Patent Application Publication
(10) Pub. No.: US 2019/0171928 A1
(43) Pub. Date: Jun. 6, 2019

(54) DYNAMICALLY MANAGING ARTIFICIAL NEURAL NETWORKS

(71) Applicant: Robin Young, Shanghai (CN)

(72) Inventor: Robin Young, Shanghai (CN)

(21) Appl. No.: 16/313,697

(22) PCT Filed: Jun. 27, 2017
(86) PCT No.: PCT/US2017/039414

§ 371 Date: Dec. 27, 2018

Related U.S. Application Data
(60) Provisional application No. 62/354,825, filed on Jun. 27, 2016.
(60) Provisional application No. 62/369,124, filed on Jul. 31, 2016.

(51) Int. Cl. G06N 3/04; G06N 3/08; G06Q 10/06; G06Q 10/10; G06K 9/62; G06N 20/20

(52) U.S. Cl. CPC G06N 3/0454; G06N 3/082; G06N 20/20; G06Q 10/1053; G06K 9/6256; G06Q 10/063112

(57) ABSTRACT

In some embodiments, the disclosed subject matter involves using socket layers with a plurality of artificial neural networks in a machine learning system to create customizable inputs and outputs for a machine learning service. The machine learning service may include a plurality of convolutional neural networks and a plurality of pre-trained fully connected neural networks to find the best fits. In an embodiment, when the customized input or output data is not a good fit with the pre-trained artificial neural networks, a socket layer may automatically request additional convolutional layers or new training of a neural network to dynamically manage the machine learning system to accommodate the customized input or customized output. Other embodiments are described and claimed.

### CROSS-REFERENCE TO RELATED APPLICATIONS

This application is related to and claims the benefit of U.S. Patent Application No. 62/354,825, filed Jun. 27, 2016, and U.S. Patent Application No. 62/369,124, filed Jul. 31, 2016, each of which is incorporated herein by reference in its entirety.

### TECHNICAL FIELD

An embodiment of the present subject matter relates generally to the field of computer software, and, more specifically but without limitation, to customizing inputs and outputs for a machine learning service, including in the field of natural language processing, deep learning, and artificial intelligence.

### BACKGROUND

Various mechanisms may be used for predictive models and matching engines. Many matching engines use trained models, where the models are trained using artificial neural networks (ANNs). However, an existing ANN is limited to models previously trained where input and output data must conform to the parameters of the trained models. Thus, an existing ANN may limit the type of predictions or matching available, based on previous training.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a flow chart for an exemplary method to create a predictive model, according to an embodiment;

FIG. 2 is an illustration of an artificial neural network including convolutional layers and using customizable input and output layers, according to an embodiment;

FIG. 3 is a flow chart of a method using a custom input layer, according to an embodiment;

FIG. 4 is a flow chart of a method using a custom output layer, according to an embodiment;

FIG. 5 is a flow chart of a method for using a socket layer for input data, according to an embodiment;

FIG. 6 is a flow chart of a method for using a socket layer for output data, according to an embodiment;

FIG. 7 illustrates a flow chart of a method to create a predictive model, according to an embodiment;

FIG. 8 is a block diagram of a matching platform, according to an embodiment;

FIG. 9 is an example of a context and language matching system, according to an embodiment;

FIG. 10 illustrates an example user interface for a matching platform, according to an embodiment;

FIG. 11 is a block diagram illustrating a request of information from a subject to make a match, according to an embodiment;

FIG. 12 is a block diagram illustrating a request of data from a subject to be modeled, according to an embodiment; and

FIG. 13 is a block diagram illustrating a request for third party data to be modeled, according to an embodiment.

### SUMMARY

Embodiments as described herein include an apparatus, and a method to combine computer programs, processes, symbols, data representations and sensors to allow users to customize a model that predicts behavior of an individual, entity, organization or group through any combination of language, speech, motion, physical conditions, environmental conditions or other indicia using contextual analysis of machine learning services. Embodiments may enable the machine learning service to make predictions from data and reactions to stimulus without the need to train a specific model for that specific data set or reaction. In at least one embodiment techniques are disclosed to customize inputs and outputs for a machine learning service to predict individual, situational, or organizational behavior based on plurality of physical, communicative, organizational, chemical and environmental contexts. Automatic dynamic changes to either a convolutional layer or newly trained neural network model may be made to provide improved fit of customized input and output data to a plurality of artificial neural networks in the machine learning service.

In at least one embodiment, a method and apparatus are described to utilize the customized model to assess and match people to job functions, corporate cultures, locations and activities through machine learning service. In an embodiment, a method is described, as a machine-learning service that may understand the intricacies of a job over time and predict suitable matches as they are identified. In another embodiment, an apparatus is described that may perform this service for employers. It will be understood that embodiments of the model using customized input and output layers may be applied to various matching and predictive applications, and is not limited to job and candidate matching.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter relates to improved machine learning and generation of predictive models. Predictive models are typically made from predefined input and output layers that are trained by statistical models. When any of the underlying inputs or outputs are adjusted, the models must be retrained to account for changes in the underlying schema. This is a major limitation for the speed, accuracy, and flexibility of existing systems.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

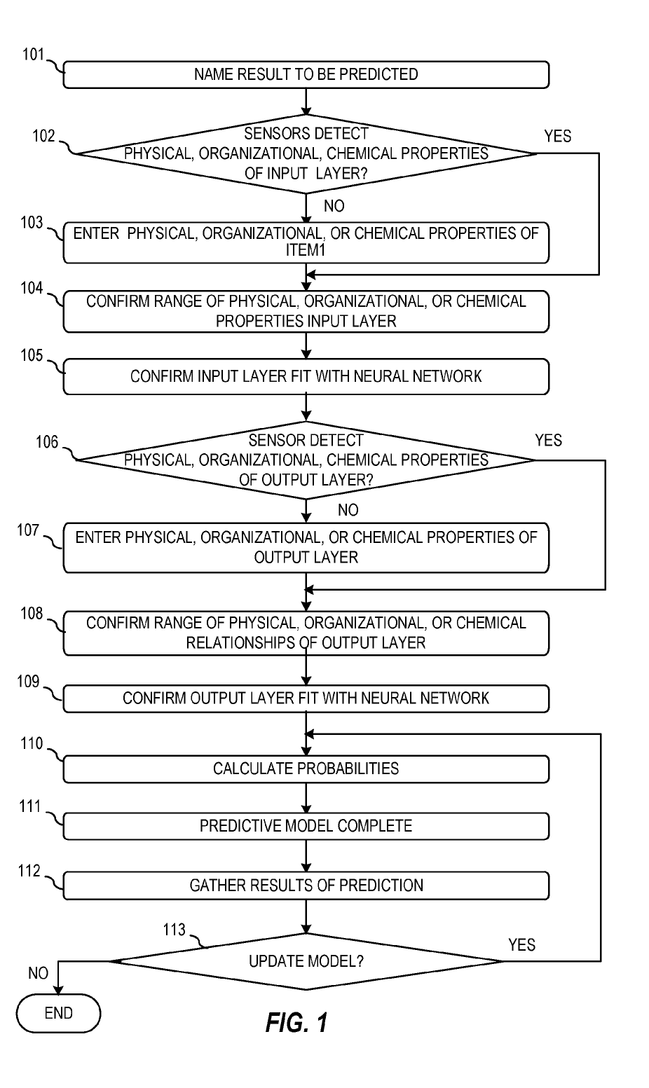

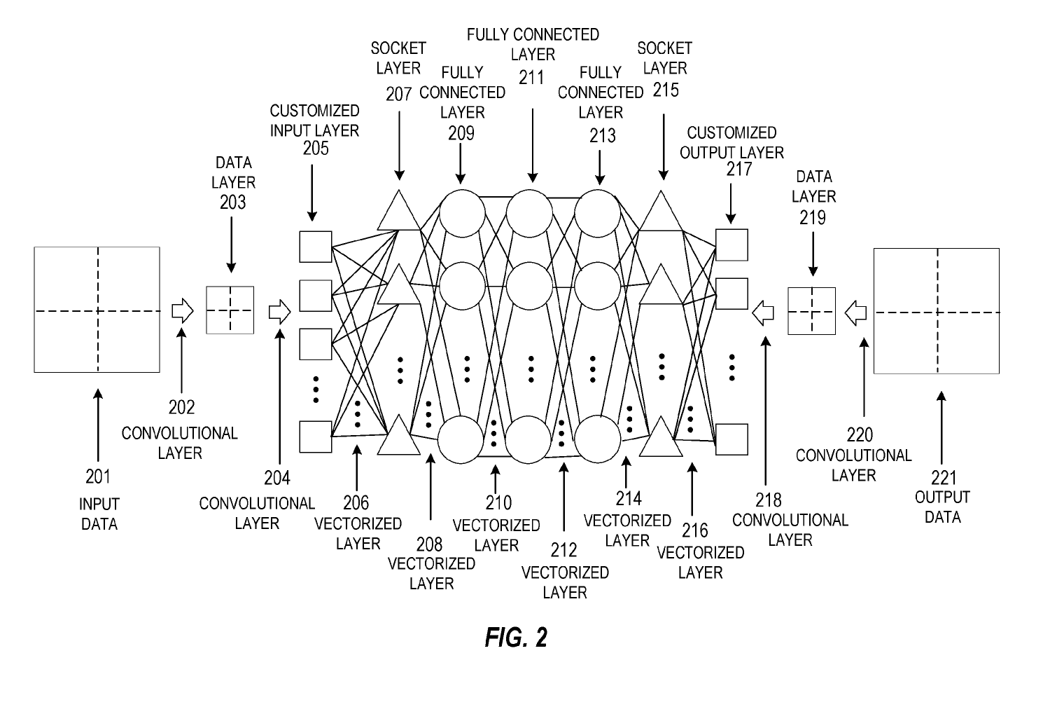

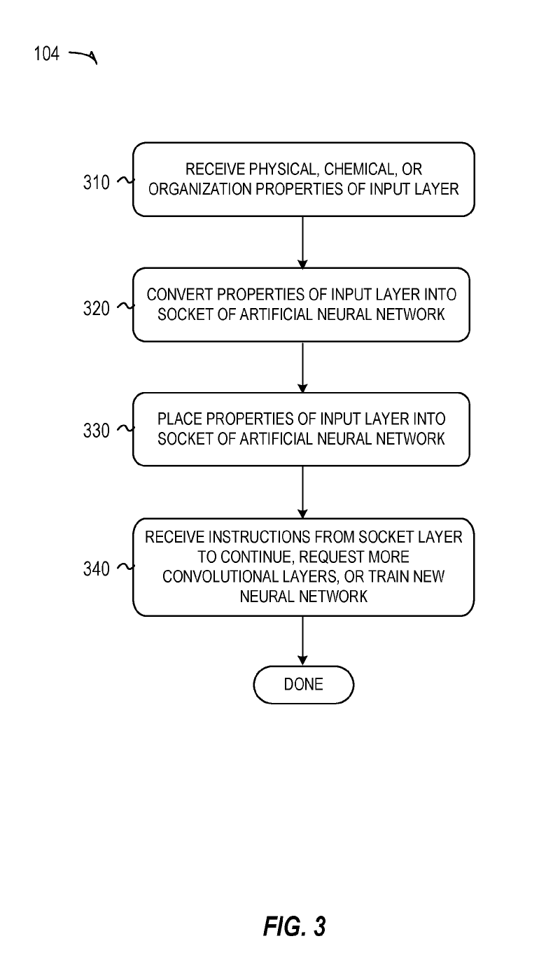

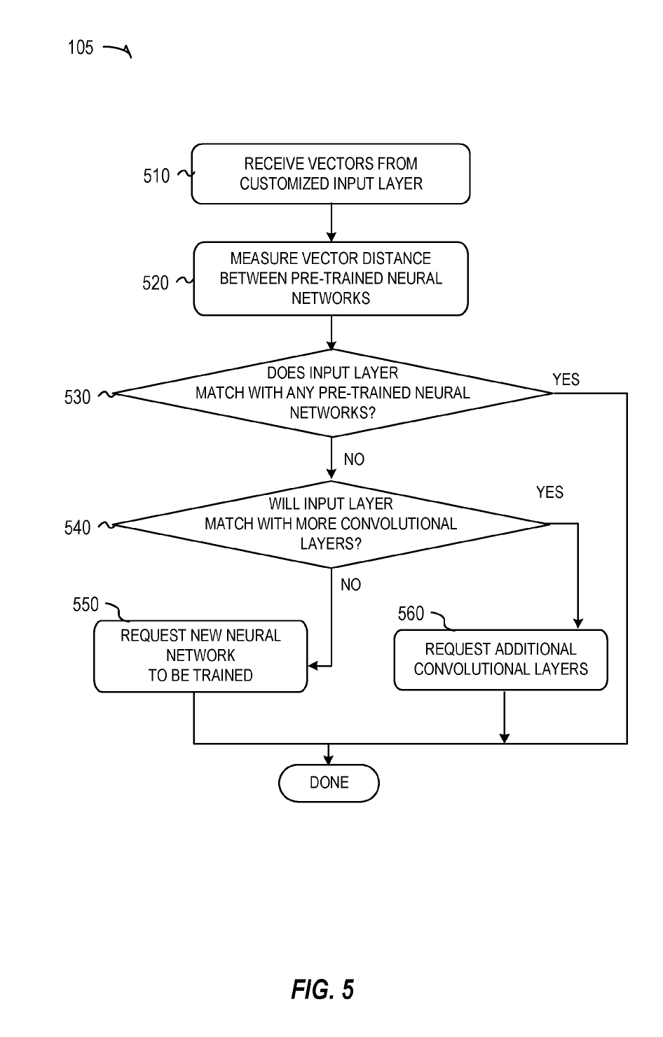

FIG. 1 illustrates a flow chart for an exemplary method to create a predictive model, according to an embodiment. In block 101, a user may name, or identify a trait, product, behavior, or situation to be modeled. The user may choose to use an external sensor that provides measurements for properties of chemical, physical, or organizational items of the input layer for an artificial neural network. If there is no sensor to detect such properties, as determined in block 102, the user may enter properties with a graphical interface at a block 103. In an embodiment, the input data may correspond to a block 201 in FIG. 2 to be described more fully, below. In block 104, the logic may dynamically confirm the range of physical, organization, or chemical propertied in the input layer. The fit of the input layer may confirmed with a socket layer, as well. This fit confirmation is described in more detail in conjunction with FIG. 3. At block 105 the socket layer may confirm the fit with a number of pre-trained neural networks, or request additional processes as detailed in FIG. 5. It will be understood that a fit of data to the various layers may deemed to be a close fit, or a sufficient fit based on mathematical analysis of differences or distances between and among data vectors representing the input and output data. In practice, measurements and thresholds for a sufficient or close fit may be predefined.

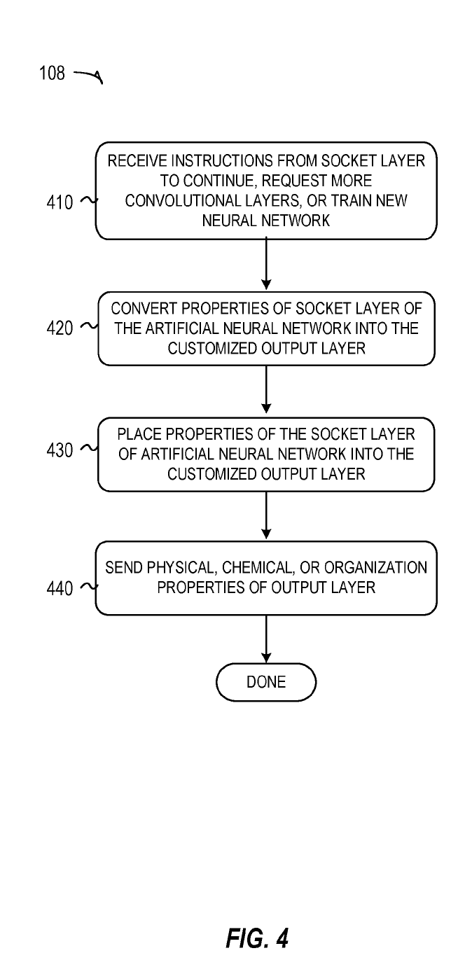

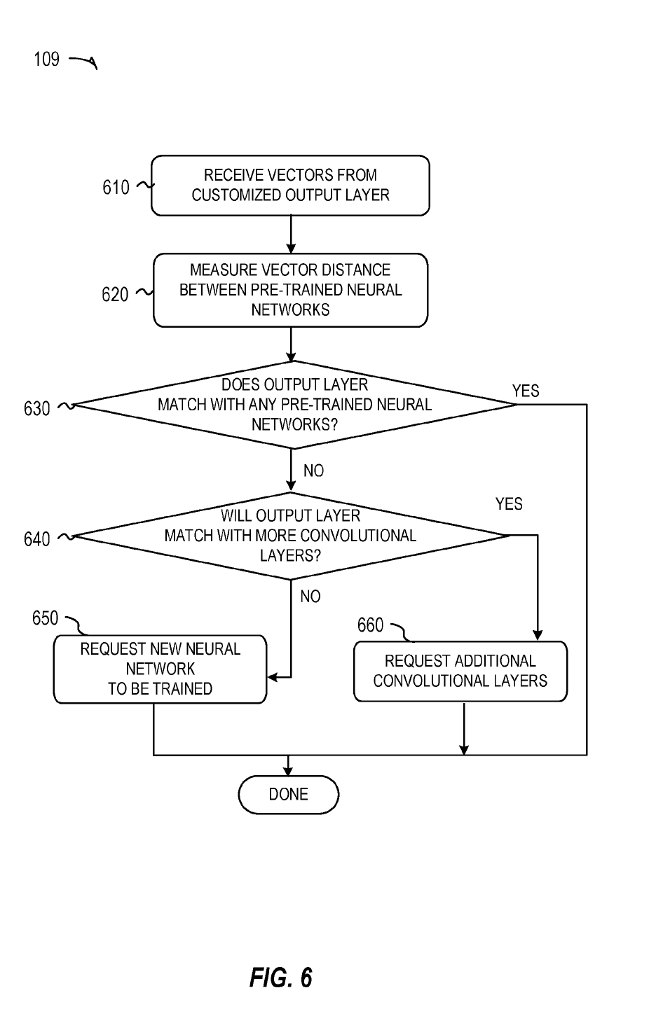

The user may choose to use an external sensor that provides measurements for properties of chemical, physical, or organizational items of the output layer. If there is no sensor to detect such properties, as determined in block 106, the user may enter properties with a graphical interface at a block 107. This output data may correspond to block 221 in FIG. 2. At block 108 the range of physical, organizational, or chemical relationships may be dynamically confirmed with relationship of the output layer. The socket layer may be dynamically confirmed with range of output layer. This confirmation is discussed in more detail in FIG. 4. The socket layer may confirm the fit with a number of pre-trained neural networks, in block 109, or request additional processes, as detailed in FIG. 6.

After the convolutional neural networks are confirmed and the fully connected neural networks are confirmed, an embodiment calculates probabilities of phenomena occurring, at block 110. In other words, the system builds the predictive model using the adaptive neural network as a probability engine. Given the customizable set of inputs, the system may produce a prediction for the most probable output. At block 111, the predictive model is complete. At block 112 the results of the model may be gathered. At block 113, the user may choose to update the model with results to further refine the model. When the model is updated, processing continues to regenerate probabilities in block 110.

FIG. 2 is an illustration of an artificial neural network including convolutional layers and using customizable input and output layers, according to an embodiment. Fully connected layers 209, 211 and 213, along with vectorized layers 208, 210, 212, and 214 represent a fully connected artificial neural network as may be practiced in existing systems. Embodiments as discussed herein provide a mechanism to dynamically interchange these pre-trained networks. In an embodiment, raw data 201 is input into the neural network, and followed by a convolutional layer 202. The convolutional layer 202 results in data layer 203. There may be a subsequent convolutional layer 204. It should be noted that the number of convolutional layers may depend on the complexity, size and difference between the customized input layer 205, and the input data 201. Thus, while only two convolutional layers are shown, in practice there may be fewer (e.g., one) or more than two convolutional layers. Vectorized layer 206 may vectorize the customized input layer 205 to fit into the socket layer 207. The socket layer 207 may also serve to validate the vectors coming from the customized input layer 205. This validation is more fully described in FIG. 5. Vectorized layer 208 connects the socket layer 207 to vectorize the results to connect to the first fully connected layer of the neural network, at 209. Vectorized layer 210 connects the first fully connected layer to the next set of fully connected layers 211, 212, 213.

It should be noted that the number of nodes, number of hidden layers and vectorized layers may depend on the complexity and the amount of data in the pre-trained neural networks 208-214. The last illustrated vectorized layer 214 of the fully connected neural network 208-214 may attach to the socket layer 215. It is important to note that the socket layer 215 may self-propagate and may create additional layers of sockets and output layers based on the difference between pre-trained neural networks, convolutional layers, and input/output data. Vectorized layer 216 may connect a socket layer 215 to a customized output layer 217. A convolutional layer 218 may create the output from the previous data layer 219. Convolutional layer 220 between may provide additional manipulation of output layers between data layers 219 output data 221. It should be noted that the convolutions of the output data are dependent on the difference between output data, output layer, and the socket layer. Thus, the number of convolutional layers, socket and output layers may be highly variable.

FIG. 3 is a flow chart of a method using a custom input layer, according to an embodiment. FIG. 4 is a flow chart of a method using a custom output layer, according to an embodiment. FIG. 3 and FIG. 4 are complementary, akin to mirror images of one another, and describe the function of the input and output layer. In an embodiment, FIG. 3 may represents the process 104 of FIG. 1. An input layer may receive the properties of input data (e.g., physical, chemical or organizational) in block 310. The input layer may connect to the vectorization layer at a block 320. In an embodiment, the properties of the input layer may be converted into the properties of the socket layer of the artificial neural network. At block 330 socket layer makes calculations about the fit of vectors. The properties of the input layer may be placed into the socket of the artificial neural network if there is a proper fit. At block 340 the socket layer may send the results of the calculations back to the input layer to confirm or request additional steps. If there is a fit, then the socket layer may send instructions to continue. If there is not fit, then the socket layer may request more convolutional layers to be provided, or request training of a new neural network

In an embodiment, FIG. 4 represents the process 108 of FIG. 1. If the output data at the output socket layer is not in range or proper fit for the customized output layer then training of additional neural networks may be required. Further, if the output data is not a good fit for the customized output layer, it may be possible to generate additional convolutional layers to cure the fit issue. For instance, the range of physical, organizational, or chemical relationships of output layer may be confirmed. If the range is acceptable, the socket layer may send instructions to continue, in block 410. If the range or relationships are not acceptable, the socket layer may request more convolutional layers or request new neural networks to be trained. Once the properties at the socket layer are acceptable, they may be converted into a form acceptable for the customized output layer in block 420, and then placed into the customized output layer, in block 430. The physical, chemical, or organization properties of output layer may then be sent, in block 440.

FIG. 5 and FIG. 6 illustrate embodiments for utilizing a socket layer with an artificial neural net as pathways to/from customized out and input layers. Both figures are virtual mirror images of one another. FIG. 5 is a flow chart of a method for using a socket layer for input data, according to an embodiment, and may correspond to block 105 of FIG. 1. At block 510, socket layer may receive vectorized input from the customized input layer. At block 520, the socket layer may measure the vector difference between the pre-trained neural networks and the vectors from input layer. At block 530, the socket layer assesses whether there are any matches from the customized input layer with pre-trained networks. If yes, then the process is done. If no, at block 540, the socket layer may assess if more convolutions will allow a match. If no, then the socket layer may request additional neural networks to be trained at block 550. If the block 540 assessment is yes, then the socket layer may request additional convolutional layers, at block 560. This process of requesting additional convolutional layers and/or new trained networks may continue until there is sufficient match between the customized input layer and pre-trained (original or newly trained) neural networks.

FIG. 6 is a flow chart of a method for using a socket layer for output data, according to an embodiment, and may correspond to block 109 of FIG. 1. At block 610, socket layer may retrieve vectorized output parameters from the customized output layer. At block 620, the socket layer may measure the vector difference between the pre-trained neural networks and the vectors for the output layer. At block 630, the socket layer assesses whether there are any matches from the customized output layer with vectorized data from the pre-trained networks. If yes, then the process is done. If no, at block 640, the socket layer may assess if more convolutions will allow a match. If no, then the socket layer may request additional neural networks to be trained at block 650. If the block 640 assessment is yes, then the socket layer may request additional convolutional layers, at block 660. This process of requesting additional convolutional layers and/or new trained networks may continue until there is sufficient match between vectors from the pre-trained (original or newly trained) neural networks and the customized output layer.

Embodiments of the customizable machine learning service are described generically, above. Example uses of the service may include a wide variety of applications, depending on data sets available and desired output. For instance, the system as described may be applied to any of the following, without limitation:

Assessing market feasibility of a new product;

Medical diagnostics;

Predicting taste or chemical efficacy based on chemical properties;

Recommending candidates to employers;

Recommending jobs to candidates;

Recommending skills to employers or candidates;

Unsupervised learning tasks with previously undefined outputs;

Classifying skills for jobs;

Predicting duration of employment for candidates;

Recommending salary and benefits for candidates;

Competitive analysis of markets, organizations, governments, etc.;

Predicting likelihood of a stranger to commit a crime;

Predicting likelihood to purchase an item;

Predicting likelihood of defaulting on a promise or loan;

Recommending best candidates for a special offer; and

Predicting best fit for a personality match for dating and romance.

For illustrative purposes, an application of the customizable machine learning system for assessing and matching people to job functions, corporate cultures, locations and activities through is described below. It will be understood that this is only one example of an application of the customizable system and that the system may be applied to other prediction and matching services without limitation. In an example, recruiting and pre-employment assessment may include reviewing candidates' resumes and pre-employment questionnaires or tests. Resumes may be scanned for key words and phrases, and sorted for easy query. Tests may serve to reduce the number of unsuitable applicants. In an example, questions may be multiple choice, or true/false, scoring candidates on a one-dimensional plane, e.g. 0-100.

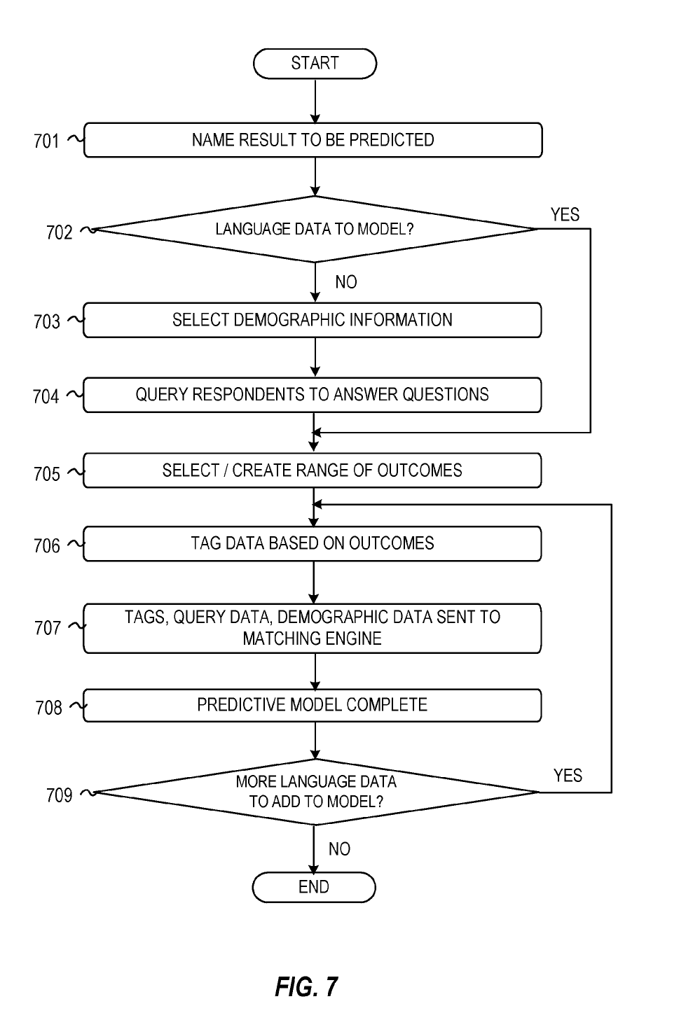

FIG. 7 illustrates a flow chart of a method to create a predictive model, according to an embodiment. As indicated by block 701, an employer may name a trait or result to be modeled. At block 702, the employer may choose to enter existing data or to create a new query. If there is no language data to model, processing may continue at block 703, where the employer may specify demographic information to further target modeling. The employer may create a query at a block 704 which may include open-ended questions, or other contextual data retrieved from social media, mobile devices, Internet browsers, location-based services or other means. The query at the block 704 may be devised for individuals who serve as the subject on which the model is created (e.g., respondents or candidates). Receipt of answers, or data, may be achieved through a Web interface, mobile application, or other computer program designed to retrieve data from other sources.

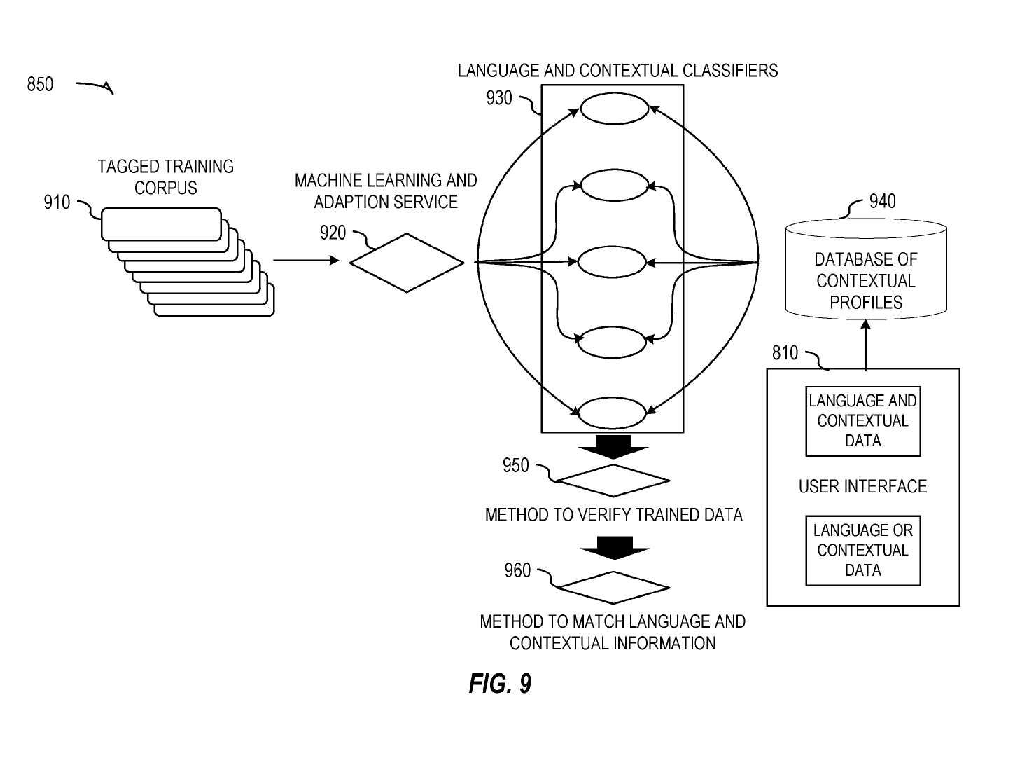

The query at the block 704 may be used to dynamically generate a range of outcomes to model at block 705. At block 706 an employer may tag the queried subjects based on the desired outcomes selected in the block 705. At block 707, data may be sent to a matching engine, or similar system, such as described in FIG. 9. At block 708, matching engine may process data and return a predictive model to a database for use, and the predictive model is complete. At block 709, the employer may select to add more data to the model, which may result in an improved predictive model.

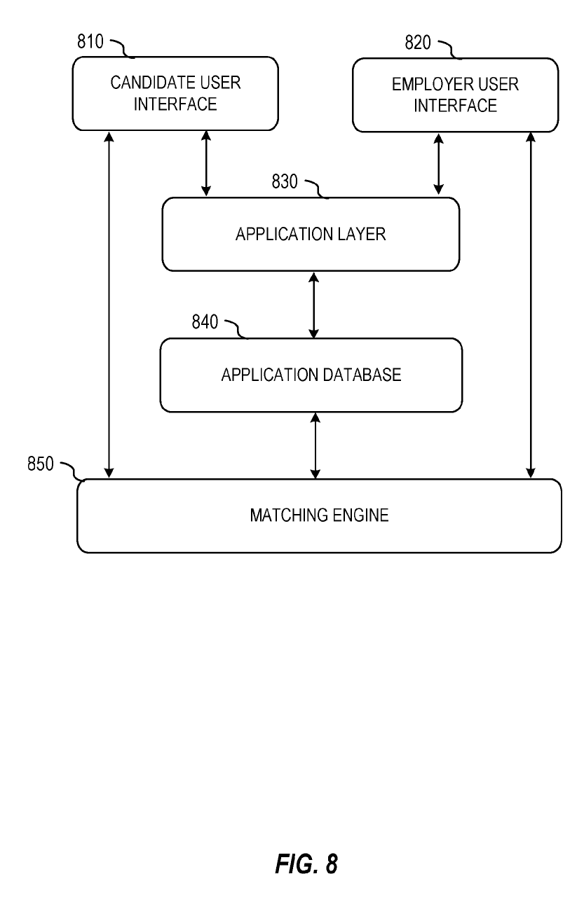

FIG. 8 is a block diagram of a matching platform, or service, according to an embodiment. A candidate user interface 810 and an employer user interface 820 may communicate with an application layer 830 and matching engine 850. The interfaces 810, 820 may be implemented as Web pages, mobile applications, or other computer implemented logic. The application layer 830 may serves the candidate user interface 810 and employer interface block 820. Results from the matching engine 850 may be served directly to both candidate user interface 810 and employer user interface. An application database 840 may hold the application data, and may selectively store data from the matching engine 850.

FIG. 9 is an example of a context and language matching system such as may be implemented for matching engine 850, according to an embodiment. Tagged training corpus 910 containing large amounts of behavioral and natural language information may be used for training. The tagged training corpus data 910 may be passed to a machine-learning and adaptation service 920. The output of machine learning and adaptation service 920 may include language and contextual classifiers 930, which may be further refined and categorized through the database of contextual profiles at a block 940. The contextual profiles 940 may be generated from a combination of language and contextual data collected from user interface 810. The language and contextual classifiers may be verified at 950 to ensure predictive reliability. The language information may be matched 960 to contextual information.

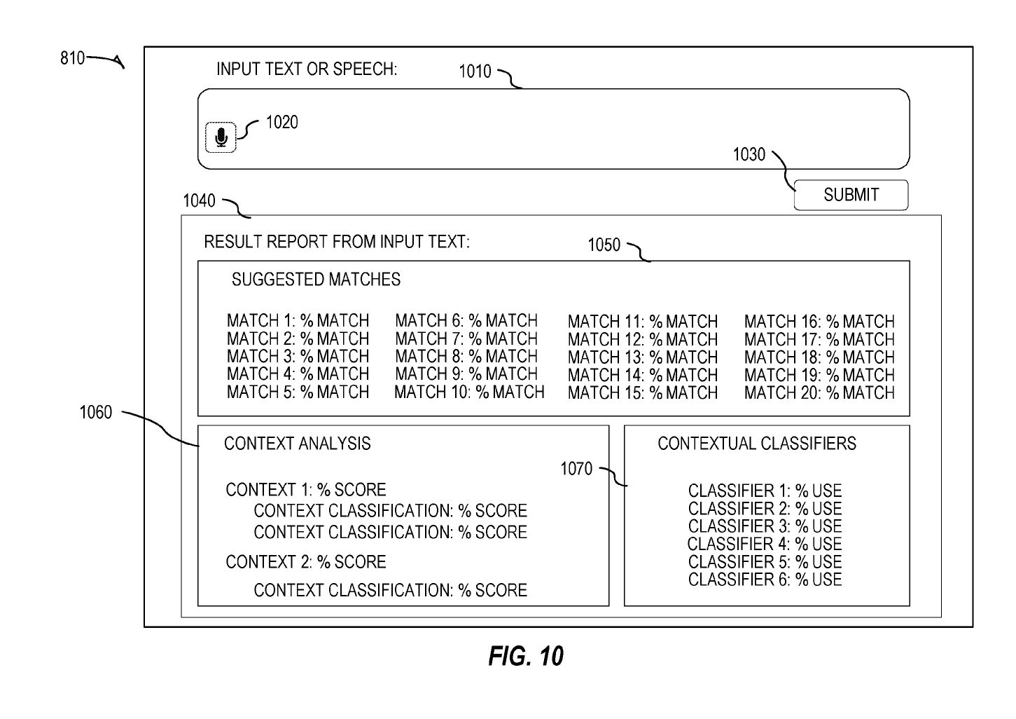

FIG. 10 illustrates an example user interface for a matching platform/service, according to an embodiment. In an embodiment, FIG. 10 illustrates a candidate user interface as shown at block 810. In an example user interface, a text entry space 1010 may be provided for entering responses prompted from a request to the user for an open-ended question from the employer. When a suitable microphone is available, entering speech content may be operable by clicking icon 1020. Once entry is complete the text may be submitted for matching by selecting a submit button 1030. A report of results for the entered text may be displayed at results area 1040. Results may include suggested matched, for instance, in a ranked list 1050. In an embodiment, a candidate user interface and employer user interface may be operable in the same application, or be implemented as separate processes. In an example, an employer user interface may display a ranked list of possible matches determined by a method to match language and contextual information as shown in 1060, 1070. In an example, the candidate user interface may not display the results, but only the input area 1020.

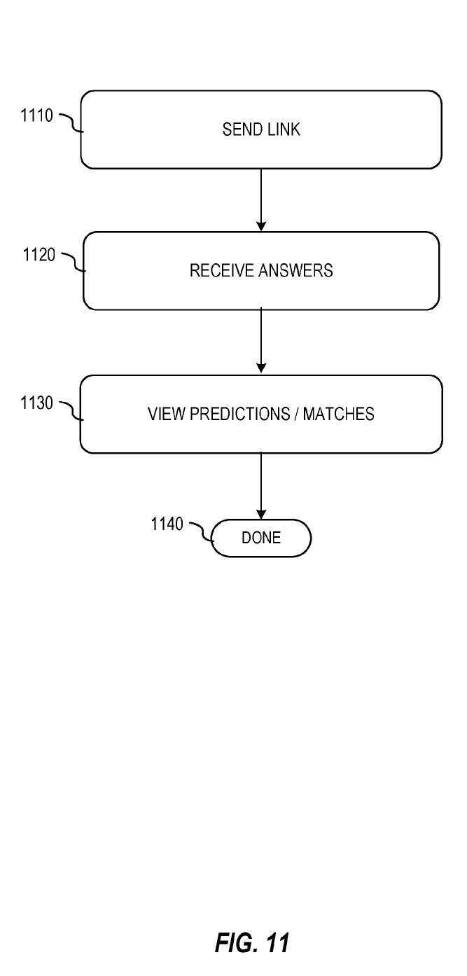

FIG. 11 is a block diagram illustrating a request of information from a subject to make a match, according to an embodiment. In an example, an employer user interface, such as described at block 820 may be used. The employer may send a link for a set of questions to a candidate to predict performance behavior, in block 1110. The system may receive an answer at block 1120 where the candidate may answer questions with voice, text, video or a combination thereof. At block 1130, the employer may view the predictions, or matches of the model created, for instance, as described in in FIG. 7.

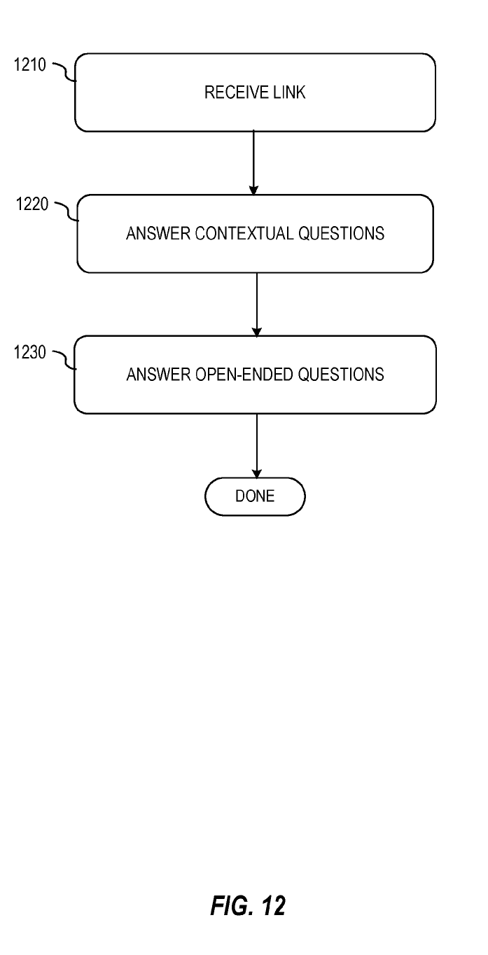

FIG. 12 is a block diagram illustrating a request of data from a subject to be modeled, according to an embodiment. The prediction may be positive or negative, and may be any manifestation of a human, animal, natural, organizational or machine behavioral element, as is relevant to the dataset and trained models. At block 1210, the subject may receive a link for input. At block 1220, the subject may provide contextual answers about their behavior and preferences. The subject may then answer open-ended questions about behavioral situations, at block 1230.

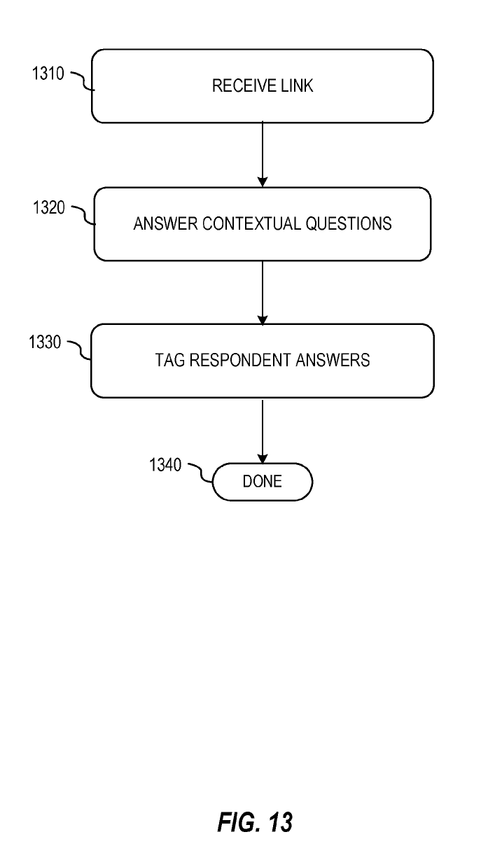

FIG. 13 is a block diagram illustrating a request for third party data to be modeled, according to an embodiment. In an embodiment, an application may collect third party data on subjects to be modeled from parties associated with subjects. For instance, the third party may receive a link to the application, at block 1310. The third party may answer contextual questions about situational environment for the subject at block 1320. At block 1330, the third party may select relevant tags of subjects, where the tags may be defined in conjunction with FIG. 7. Third party information may be forwarded to the requestor (e.g., the employer).

In an embodiment, the matching service may send notifications to candidates for them to answer questions via email, short message service (SMS), recorded phone message, or other convenient methods of communication. The matching service may receive answers via text, voice, and video, etc.

Advantages of the embodiments as described herein may include, without limitation, a machine-learning service to recommend candidates for jobs based on current successful employees' work product and language. Many companies currently have assessment data, and try to draw conclusions from the data. Yet there is a clear lack of actionable methods and suggestions in current methods. Embodiments herein may utilize that open-ended information to make predictions for the performance of prospective employees. Use of a customizable artificial neural network, as described above, enables data types that has unlikely been trained before to automatically and dynamically alter the system by generating additional convolutional layers or trained models, when necessary.

In the case of job and candidate matching, an improvement may be higher better placement accuracy. Further, in using semantic and sentiment analysis tools, richer data may available than in current methods. This allows for predictive recommendations comparing personality profiles. In an embodiment, rather than being limited to one-dimensional assessment scores, candidates may be assessed on two or more dimensions, automatically, without human judgment. Specific traits may be assessed with more tact, as respondents are required to provide formless answers, or rather, answers with self-directed form.

Embodiments may allow maximum persistence of data, enabling new processes to assess the data with each advance in natural language processing technology. This is in stark contrast to current assessment paradigms where multiple choice questions limit the data that can be extracted from answers. The only data points for these types of assessments are the actual selections by candidates. Any further analytical benefit with technological advancement is limited by design.

Embodiments described herein may be suitable for many uses beyond recruitment; matching candidate and job opportunities. There may be applications in consumer related uses, as well. Similar methods using natural language processing may analyze matches for dating applications. By using open ended writing sample, as described above, to match personality profiles rather than using a simple multi-choice questionnaire, the resulting data set may be both simpler and richer.

Future uses may involve two types of inputs. The first type is direct input mediums from users. This may include voice recognition tools, other textual input devices, or even direct brain link. The second type of input is passive input. These may involve conversation, emails, and text chat.

Examples may include subject matter such as a method, means for performing acts of the method, at least one machine-readable medium including instructions that, when performed by a machine cause the machine to performs acts of the method, or of an apparatus or system for customized input/output for machine learning in predictive models, according to embodiments and examples described herein.

The techniques described herein are not limited to any particular hardware or software configuration; they may find applicability in any computing, consumer electronics, or processing environments. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system, which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the scope of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

1-24. (canceled)

25. A computer implemented method for managing a plurality of artificial neural networks in a machine learning system, comprising:
receiving input data for a customized input data layer for the plurality of artificial neural networks, the input data having identified physical,
organizational or chemical properties, and processing the input data by at least one convolutional layer to produce convolutionally processed input data;
confirming a range of the identified physical, organizational or chemical properties of the input data;
confirming that the convolutionally processed input data fits with the customized input layer;
responsive to an indication that the convolutionally processed input data fits with the customized input layer: converting properties of the customized input layer into an input socket layer of the plurality of artificial neural networks, placing the properties of the customized input layer into the input socket layer of the plurality of artificial neural networks, and proceeding to prepare an output prediction using the plurality of artificial neural networks; and
responsive to an indication that the convolutionally processed input data does not fit with the customized input layer, requesting at least one of an additional convolutional layer process or a training of a new neural network model, and proceeding to prepare an output prediction,
wherein the input socket layer is configured to automatically and dynamically initiate changes to the machine learning system to accommodate the input data.

26. The computer implemented method as recited in claim 25, further comprising:
receiving at an output socket layer, an output prediction from the plurality of artificial neural networks;
confirming the range of the identified physical, organizational or chemical properties of the output prediction;
confirming the output prediction is a fit with a customized output layer; responsive to an indication that the output prediction fits with the customized output layer: converting properties of the output prediction by an output socket layer to the customized output layer, placing the properties of the output socket layer into the customized output layer; and
responsive to an indication that the output prediction at the output socket layer does not fit with the customized output layer, requesting at least one of an additional output convolutional layer process or a training of a new neural network model, and placing the properties of the output socket layer into the customized output layer,
wherein the output socket layer is configured to automatically and dynamically initiate changes to the machine learning system to accommodate the output prediction.

27. The computer implemented method as recited in claim 26, further comprising:
calculating probabilities of phenomena occurring in a predictive model; processing the customized output layer through a convolutional model to produce a convoluted output prediction; and
providing the convoluted output prediction to a user as output data.

28. The computer implemented method as recited in claim 26, wherein confirming the output prediction is a fit with a customized output layer further comprises:
receiving an output vector from the customized output layer;
measuring a distance between the output vector and a pre-trained model of the plurality of artificial neural networks, wherein the distance indicates whether there is a sufficient match between the customized output layer and the pre-trained model;
responsive to an indication of a sufficient match with the pre-trained model and the output vector, indicating that the output prediction fits with the customized output layer;
responsive to an indication that there is not a sufficient match with the pre-trained model and the output vector; identifying whether the output vector is a sufficient match with an additional output convolutional layer; responsive to an indication that the output vector is a sufficient match with an additional output convolutional layer, automatically requesting processing of an additional output convolutional layer; and
responsive to an indication that the output vector is not a sufficient match with an additional output convolutional layer, automatically requesting the training of the new neural network model for use with the plurality of artificial neural networks.

29. The computer implemented method as recited in claim 25, wherein confirming that the convolutionally processed input data fits with the customized input layer further comprises:
receiving an input vector from the customized input layer;
measuring a distance between the input vector and a pre-trained model of the artificial neural network, wherein the distance indicates whether there is a sufficient match between the input data and the pre-trained model;
responsive to an indication of a sufficient match with the pre-trained model and the input vector, indicating that the convolutionally processed input data fits with the customized input layer;
responsive to an indication that there is not a sufficient match with the pre-trained model and the input vector; identifying whether the input vector is a sufficient match with an additional convolutional layer;
responsive to an indication that the input vector is a sufficient match with an additional convolutional layer, automatically requesting processing of an additional convolutional layer; and
responsive to an indication that the input vector is not a sufficient match with an additional convolutional layer, automatically requesting the training of the new neural network model.

30. The computer implemented method as recited in claim 25, further comprising:
identifying properties to be trained in the machine learning system; selecting a range of outcomes for the output prediction;
tagging data based on the selected range of outcomes, to generate tagged data; and providing the tagged data to train a first neural network model.

31. The computer implemented method as recited in claim 30, wherein the first neural network model includes language and contextual classifiers for natural language responses.

32. The computer implemented method as recited in claim 31, wherein the output prediction provides matching for a job matching service.

33. The computer implemented method as recited in claim 32, wherein the natural language responses include open ended textual response from a job candidate subscribed to the job matching service, responsive to a request from an employer for information.

34. The computer implemented method as recited in claim 33, wherein the first neural network model uses the tagged data to identify semantic and sentiment contextual data in the natural language response.

35. A computer readable storage medium having instructions stored thereon, the instructions when executed on a machine cause the machine to perform the method of claim 25.

36. A machine learning system having a plurality of artificial neural networks and using customized layers, comprising;
a processor coupled to memory, including a plurality of trained neural network models;
a customized input layer coupled to an input socket layer, wherein the input socket layer is configured to provide input data to a plurality of fully connected layers of the plurality of trained neural network models, wherein the customized input layer is configured to receive the input data processed by at least one input convolutional layer;
a customized output layer coupled to an output socket layer, wherein the output socket layer is configured to receive output data from the plurality of fully connected layers of the plurality of trained neural network models, wherein the customized output layer is configured to send the output data to at least one output convolutional layer configured to generate output data; and
input fit logic operable by the processor configured to initiate automatic and dynamic changes to the machine learning system when the customized input layer is identified as not being a sufficient fit with the plurality of trained neural network models.

37. The machine learning system as recited in claim 36, wherein the input fit logic is further configured to request at least one of an additional convolutional layer process or a training of a new neural network model to make the dynamic change of the machine learning system, responsive to an indication that the customized input layer is identified as not being a sufficient fit with the plurality of trained neural network models.

38. The machine learning system as recited in claim 37, wherein the input fit logic is further configured to:
receive an input vector from the customized input layer;
measure a distance between the input vector and a trained model of the plurality of trained neural network models, wherein the distance indicates whether there is a sufficient match between the input data and the trained model; responsive to an indication of a sufficient match with the trained model and the input vector, indicate that the input data fits with the customized input layer;
responsive to an indication that there is not a sufficient match with the trained model and the input vector; identify whether the input vector is a sufficient match with an additional convolutional layer;
responsive to an indication that the input vector is a sufficient match with an additional convolutional layer, automatically request processing of an additional convolutional layer; and
responsive to an indication that the input vector is not a sufficient match with an additional convolutional layer, automatically request the training of the new neural network model.

39. The machine learning system as recited in claim 37, further comprising: tagging logic operable by the processor to:
identify properties to be trained in the machine learning system; select a range of outcomes for the output prediction; tag data based on the selected range of outcomes, to generate tagged data; and
provide the tagged data to train a first neural network model.

40. The machine learning system as recited in claim 39, wherein the first neural network model includes language and contextual classifiers for natural language responses.

41. The machine learning system as recited in claim 40, wherein the output prediction provides matching for a job matching service.

42. The computer implemented method as recited in claim 41, wherein the natural language responses include open ended textual response from a job candidate subscribed to the job matching service, responsive to a request from an employer for information.

43. The machine learning system as recited in claim 42, wherein the first neural network model uses the tagged data to identify semantic and sentiment contextual data in the natural language response.

44. The machine learning system as recited in claim 36, further comprising:
output fit logic operable by the processor configured to initiate dynamic changes to the machine learning system when the customized output layer is identified as not being a sufficient fit with the plurality of trained neural network models.

45. The machine learning system as recited in claim 44, wherein the output fit logic is further configured to: receive at an output socket layer, an output prediction from the artificial neural network;
confirm the range of the identified physical, organizational or chemical properties of the output prediction;
confirm the output prediction is a fit with a customized output layer;
responsive to an indication that the output prediction fits with the customized output layer: convert properties of the output prediction by an output socket layer to the customized output layer, placing the properties of the output socket layer into the customized output layer; and
responsive to an indication that the output prediction at the output socket layer does not fit with the customized output layer, requesting at least one of an additional output convolutional layer process or a training of a new neural network model, and placing the properties of the output socket layer into the customized output layer.

46. The machine learning system as recited in claim 45, wherein the logic is further configured to:
receive an output vector from the customized output layer;
measure a distance between the output vector and a trained model of the artificial neural network, wherein the distance indicates whether there is a sufficient match between the customized output layer and the trained model;
responsive to an indication of a sufficient match with the trained model and the output vector, indicate that the output prediction fits with the customized output layer;
responsive to an indication that there is not a sufficient match with the trained model and the output vector;
identify whether the output vector is a sufficient match with an additional output convolutional layer;
responsive to an indication that the output vector is a sufficient match with an additional output convolutional layer, automatically request processing of an additional output convolutional layer; and
responsive to an indication that the output vector is not a sufficient match with an additional output convolutional layer, automatically request the training of the new neural network model.

47. The machine learning system as recited in claim 36, wherein the input socket layer and output socket layer are configured to enable the dynamic changes to the machine learning system to provide logic for fitting the plurality of artificial neural networks to the customized input layer and the customized output layer.

48. A machine learning system comprising
means to performing the operations of claim 25.
